(19) United States
(12) Patent Application Publication
(10) Pub. No.: US 2025/0097977 A1
(43) Pub. Date: Mar. 20, 2025

(54) METHOD FOR TRANSMITTING/RECEIVING UPLINK SIGNAL AND APPARATUS FOR SAME

(71) Applicant: LG ELECTRONICS INC., Seoul (KR)

(72) Inventors: Sechang MYUNG, Seoul (KR); Suckchel YANG, Seoul (KR); Seonwook KIM, Seoul (KR)

(21) Appl. No.: 18/726,969

(22) PCT Filed: Jan. 4, 2023
(86) PCT No.: PCT/KR2023/000137

§ 371 Date: Jul. 5, 2024

(30) Foreign Application Priority Data
Jan. 7, 2022 (KR) 10-2022-0003008

(51) Int. Cl. H04W 74/0808; H04W 16/28; H04W 72/044

(52) U.S. Cl. CPC H04W 74/0808; H04W 16/28; H04W 72/044

(57) ABSTRACT

Disclosed is a method by which a terminal performs UL transmission in a wireless communication system. In particular, the method comprises transmitting an LBT failure indication to an MAC entity on the basis of first LBT based on a first sensing beam from among a plurality of sensing beams being failed, selecting a second sensing beam different from the first sensing beam, from among the plurality of sensing beams, on the basis of the number LBT failure indications transmitted by continuous failure of the first LBT reaching a maximum counter value associated with the first sensing beam, and performing the UL transmission through a transmission beam covered by the second sensing beam, on the basis of second LBT based on the second sensing beam being successful, wherein maximum counter values associated with the plurality of sensing beams may be individually associated with the plurality of sensing beams, respectively.

### CROSS-REFERENCE TO RELATED APPLICATIONS

This application is the National Stage filing under 35 U.S.C. 371 of International Application No. PCT/KR2023/000137, filed on Jan. 4, 2023, which claims the benefit of earlier filing date and right of priority to Korean Application No. 10-2022-0003008 filed on Jan. 7, 2022, the contents of which are all incorporated by reference herein in their entireties.

### TECHNICAL FIELD

The present disclosure relates to a method of transmitting and receiving an uplink signal and an apparatus therefor, and more particularly, to a method of transmitting and receiving an uplink signal and an apparatus therefor when continuous LBT in performing sensing beam-based listen-before-talk (LBT) fails.

### BACKGROUND

As more and more communication devices demand larger communication traffic along with the current trends, a future-generation 5th generation (5G) system is required to provide an enhanced wireless broadband communication, compared to the legacy LTE system. In the future-generation 5G system, communication scenarios are divided into enhanced mobile broadband (eMBB), ultra-reliability and low-latency communication (URLLC), massive machine-type communication (mMTC), and so on.

Herein, eMBB is a future-generation mobile communication scenario characterized by high spectral efficiency, high user experienced data rate, and high peak data rate, URLLC is a future-generation mobile communication scenario characterized by ultra-high reliability, ultra-low latency, and ultra-high availability (e.g., vehicle to everything (V2X), emergency service, and remote control), and mMTC is a future-generation mobile communication scenario characterized by low cost, low energy, short packet, and massive connectivity (e.g., Internet of things (IoT)).

### SUMMARY

The present disclosure provides a method of transmitting and receiving an uplink signal and an apparatus therefor.

It will be appreciated by persons skilled in the art that the objects that could be achieved with the present disclosure are not limited to what has been particularly described hereinabove and the above and other objects that the present disclosure could achieve will be more clearly understood from the following detailed description.

According to the present disclosure, a method of performing uplink (UL) transmission by a user equipment (UE) in a wireless communication system includes performing first listen before talk (LBT) based on a first sensing beam from among a plurality sensing beams, transmitting an LBT failure indication to a medium access control (MAC) entity based on failure of the first LBT, counting a number of the transmitted LBT failure indications due to consistent failure of the first LBT by the MAC entity, based on that the number of the LBT failure indications reaches a maximum counter value related to the first sensing beam, selecting a second sensing beam different from the first sensing beam from among the plurality of sensing beams, performing second LBT based on the second sensing beam, and based on success of the second LBT, performing the UL transmission through a transmission beam covered by the second sensing beam, wherein maximum counter values related to the plurality of sensing beams are separately related to the plurality of sensing beams, respectively.

The first sensing beam may be related to a specific synchronization signal block (SSB) index.

Based on the failure of the first LBT, the number of LBT failure indications related to the third sensing beam related to the specific SSB index may also be counted.

The first sensing beam may cover a transmission beam known by spatial relation information or a unified transmission configuration indicator (TCI) framework.

Based on the failure of the first LBT, both a first LBT failure counter value related to the transmission beam and the second LBT failure counter value related to the first sensing beam may be counted.

The second sensing beam may be selected based on at least one of the first LBT failure counter value reaching a first maximum value and the second LBT failure counter value reaching a second maximum value.

According to the present disclosure, a user equipment (UE) for performing uplink (UL) transmission in a wireless communication system includes at least one transceiver, at least one processor, and at least one computer memory operatively connected to the at least one processor and configured to store instructions that when executed causes the at least one processor to perform operations including performing first listen before talk (LBT) based on a first sensing beam from among a plurality sensing beams, transmitting an LBT failure indication to a medium access control (MAC) entity based on failure of the first LBT, counting a number of the transmitted LBT failure indications due to consistent failure of the first LBT by the MAC entity, based on that the number of the LBT failure indications reaches a maximum counter value related to the first sensing beam, selecting a second sensing beam different from the first sensing beam from among the plurality of sensing beams, performing second LBT based on the second sensing beam, and based on success of the second LBT, performing the UL transmission through a transmission beam covered by the second sensing beam, through the at least one transceiver, wherein maximum counter values related to the plurality of sensing beams are separately related to the plurality of sensing beams, respectively.

The first sensing beam may be related to a specific synchronization signal block (SSB) index.

Based on the failure of the first LBT, the number of LBT failure indications related to the third sensing beam related to the specific SSB index may also be counted.

The first sensing beam may cover a transmission beam known by spatial relation information or a unified transmission configuration indicator (TCI) framework.

based on the failure of the first LBT, both a first LBT failure counter value related to the transmission beam and the second LBT failure counter value related to the first sensing beam may be counted.

The second sensing beam may be selected based on at least one of the first LBT failure counter value reaching a first maximum value and the second LBT failure counter value reaching a second maximum value.

According to the present disclosure, a base station (BS) for performing uplink (UL) reception in a wireless communication system includes at least one transceiver; at least one processor, and at least one computer memory operatively connected to the at least one processor and configured to store instructions that when executed causes the at least one processor to perform operations including transmitting information related to a transmission beam for the UL reception, and performing the UL reception based on information related to the transmission beam, through the at least one transceiver, wherein the UL reception is performed based on success of a first LBT based on a first sensing beam covering the transmission beam, the first sensing beam is reselected from among a plurality of sensing beams based on that a number of consistent failures of a second LBT based on a sensing beam different from the first sensing beam reaches a maximum counter value related to the second sensing beam, and maximum counter values related to the plurality of sensing beams are separately related to the plurality of sensing beams, respectively.

According to the present disclosure, a method for performing uplink (UL) reception by a base station (BS) in a wireless communication system includes transmitting information related to a transmission beam for the UL reception, and performing the UL reception based on the information related to the transmission beam, wherein the UL reception is performed based on success of a first LBT based on a first sensing beam covering the transmission beam, the first sensing beam is reselected from among a plurality of sensing beams based on that a number of consistent failures of a second LBT based on a sensing beam different from the first sensing beam reaches a maximum counter value related to the second sensing beam, and maximum counter values related to the plurality of sensing beams are separately related to the plurality of sensing beams, respectively.

According to the present disclosure, an apparatus for performing uplink (UL) transmission in a wireless communication system includes at least one processor, and at least one computer memory operatively connected to the at least one processor and configured to store instructions that when executed causes the at least one processor to perform operations including performing first listen before talk (LBT) based on a first sensing beam from among a plurality sensing beams, transmitting LBT failure indication to a medium access control (MAC) entity based on failure of the first LBT, counting a number of the transmitted LBT failure indications due to consistent failure of the first LBT by the MAC entity, based on that the number of the LBT failure indications reaches a maximum counter value related to the first sensing beam, selecting a second sensing beam different from the first sensing beam from among the plurality of sensing beams, performing second LBT based on the second sensing beam, and based on success of the second LBT, performing the UL transmission through a transmission beam covered by the second sensing beam, wherein maximum counter values related to the plurality of sensing beams are separately related to the plurality of sensing beams, respectively.

According to the present disclosure, a computer-readable storage medium includes at least one computer program for causing at least one processor to perform operations including performing first listen before talk (LBT) based on a first sensing beam from among a plurality sensing beams, transmitting LBT failure indication to a medium access control (MAC) entity based on failure of the first LBT, counting a number of the transmitted LBT failure indications due to consistent failure of the first LBT by the MAC entity, based on that the number of the LBT failure indications reaches a maximum counter value related to the first sensing beam, selecting a second sensing beam different from the first sensing beam from among the plurality of sensing beams, performing second LBT based on the second sensing beam, and based on success of the second LBT, performing UL transmission through a transmission beam covered by the second sensing beam, wherein maximum counter values related to the plurality of sensing beams are separately related to the plurality of sensing beams, respectively.

According to the present disclosure, when performing listen-before-talk (LBT) using a sensing beam, LBT failure may be determined for each sensing beam by using an LBT failure counter value related to each sensing beam, and a sensing beam may be reselected. A BWP switching or cell reselection operation may be triggered by reporting an LBT failure to a higher layer.

A channel access delay time may increase due to continuous failure of LBT, and successful LBT may be obtained and UL transmission may be possible with lower complexity than a BWP changing or cell reselection operation by changing a sensing beam through a sensing beam reconfiguration without repeating retransmission scheduling.

An uplink signal may be transmitted in an unoccupied sensing beam direction within the same frequency resource, and thus the identity of scheduled resources may be maintained rather than BWP change or cell reselection.

In terms of a base station (BS), there is no need to perform radio frequency (RF) retuning due to BWP change or cell reselection, and appropriate uplink reception is possible simply by changing a reception beam through beam correspondence, and efficient uplink transmission and reception is possible.

The effects obtainable in the present disclosure are not limited to the effects mentioned above, and other effects not mentioned are clearly understood by those skilled in the art from the description below.

### BRIEF DESCRIPTION OF THE DRAWINGS

FIG. 1 illustrates an exemplary wireless communication system supporting an unlicensed band applicable to the present disclosure.

FIG. 2 illustrates an exemplary method of occupying resources in an unlicensed band.

FIG. 3 illustrates a channel access procedure for uplink and/or downlink signal transmission in U-band applicable to the present disclosure.

FIG. 4 illustrates a plurality of listen before talk-subbands (LBT-SBs) applicable to the present disclosure.

FIG. 5 is a diagram for explaining LBT failure detection and recovery procedures.

FIG. 6 is a diagram for explaining beam-based LBT and beam group-based LBT according to an embodiment of the present disclosure.

FIG. 7 is a diagram for explaining a problem occurring in beam-based LBT according to an embodiment of the present disclosure.

FIGS. 8 to 10 are diagrams for explaining the overall operation process of a UE and a BS according to the proposed methods of the present disclosure.

FIGS. 11 and 12 are diagrams for explaining LBT failure detection and recovery procedures for each sensing beam according to the present disclosure.

FIG. 13 is a diagram showing a communication system applicable to the present disclosure.

FIG. 14 is a diagram showing a wireless device applicable to the present disclosure.

FIG. 15 is a diagram showing a vehicle or an autonomous driving vehicle applicable to the present disclosure.

### DETAILED DESCRIPTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3rd generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

While the following description is given in the context of a 3GPP communication system (e.g., NR) for clarity, the technical spirit of the present disclosure is not limited to the 3GPP communication system. For the background art, terms, and abbreviations used in the present disclosure, refer to the technical specifications published before the present disclosure (e.g., 38.211, 38.212, 38.213, 38.214, 38.300, 38.331, and so on).

5G communication involving a new radio access technology (NR) system will be described below.

Three key requirement areas of 5G are (1) enhanced mobile broadband (eMBB), (2) massive machine type communication (mMTC), and (3) ultra-reliable and low latency communications (URLLC).

Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is AR for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases in a 5G communication system including the NR system will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup may be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Finally, logistics and freight tracking are important use cases for mobile communications that enable the tracking of inventory and packages wherever they are by using location-based information systems. The logistics and freight tracking use cases typically require lower data rates but need wide coverage and reliable location information.

Similarly to licensed-assisted access (LAA) in the legacy 3GPP LTE system, use of an unlicensed band for cellular communication is also under consideration in a 3GPP NR system. Unlike LAA, a stand-along (SA) operation is aimed in an NR cell of an unlicensed band (hereinafter, referred to as NR unlicensed cell (UCell)). For example, PUCCH, PUSCH, and PRACH transmissions may be supported in the NR UCell.

On LAA UL, with the introduction of an asynchronous HARQ procedure, there is no additional channel such as a physical HARQ indicator channel (PHICH) for indicating HARQ-ACK information for a PUSCH to the UE. Therefore, accurate HARQ-ACK information may not be used to adjust a contention window (CW) size in a UL LBT procedure. In the UL LBT procedure, when a UL grant is received in the n-th subframe, the first subframe of the most recent UL transmission burst prior to the (n−3)-th subframe has been configured as a reference subframe, and the CW size has been adjusted based on a new data indicator (NDI) for a HARQ process ID corresponding to the reference subframe. That is, when the BS toggles NDIs per one or more transport blocks (TBs) or instructs that one or more TBs be retransmitted, a method has been introduced of increasing the CW size to the next largest CW size of a currently applied CW size in a set for pre-agreed CW sizes under the assumption that transmission of a PUSCH has failed in the reference subframe due to collision with other signals or initializing the CW size to a minimum value (e.g., CWmin) under the assumption that the PUSCH in the reference subframe has been successfully transmitted without any collision with other signals.

In an NR system to which various Embodiments of the present disclosure are applicable, up to 400 MHz per component carrier (CC) may be allocated/supported. When a UE operating in such a wideband CC always operates with a radio frequency (RF) module turned on for the entire CC, battery consumption of the UE may increase.

Alternatively, considering various use cases (e.g., eMBB, URLLC, mMTC, and so on) operating within a single wideband CC, a different numerology (e.g., SCS) may be supported for each frequency band within the CC.

Alternatively, each UE may have a different maximum bandwidth capability.

In this regard, the BS may indicate to the UE to operate only in a partial bandwidth instead of the total bandwidth of the wideband CC. The partial bandwidth may be defined as a bandwidth part (BWP).

A BWP may be a subset of contiguous RBs on the frequency axis. One BWP may correspond to one numerology (e.g., SCS, CP length, slot/mini-slot duration, and so on).

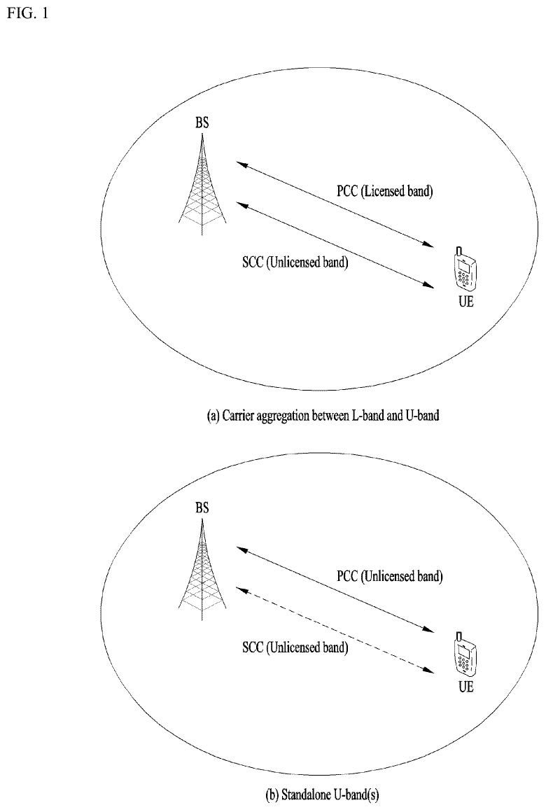

FIG. 1 illustrates an exemplary wireless communication system supporting an unlicensed band applicable to the present disclosure.

In the following description, a cell operating in a licensed band (L-band) is defined as an L-cell, and a carrier of the L-cell is defined as a (DL/UL) LCC. A cell operating in an unlicensed band (U-band) is defined as a U-cell, and a carrier of the U-cell is defined as a (DL/UL) UCC. The carrier/carrier-frequency of a cell may refer to the operating frequency (e.g., center frequency) of the cell. A cell/carrier (e.g., CC) is commonly called a cell.

When a BS and a UE transmit and receive signals on carrier-aggregated LCC and UCC as illustrated in FIG. 1(a), the LCC and the UCC may be configured as a primary CC (PCC) and a secondary CC (SCC), respectively. The BS and the UE may transmit and receive signals on one UCC or on a plurality of carrier-aggregated UCCs as illustrated in FIG. 1(b). In other words, the BS and UE may transmit and receive signals only on UCC(s) without using any LCC. For an SA operation, PRACH, PUCCH, PUSCH, and SRS transmissions may be supported on a UCell.

Signal transmission and reception operations in an unlicensed band as described in the present disclosure may be applied to the afore-mentioned deployment scenarios (unless specified otherwise).

Unless otherwise noted, the definitions below are applicable to the following terminologies used in the present disclosure.
Channel: a carrier or a part of a carrier composed of a contiguous set of RBs in which a channel access procedure (CAP) is performed in a shared spectrum.
Channel access procedure (CAP): a procedure of assessing channel availability based on sensing before signal transmission in order to determine whether other communication node(s) are using a channel. A basic sensing unit is a sensing slot with a duration of Tsl=9 us. The BS or the UE senses the slot during a sensing slot duration. When power detected for at least 4 us within the sensing slot duration is less than an energy detection threshold Xthresh, the sensing slot duration Tsl is be considered to be idle. Otherwise, the sensing slot duration Tsl is considered to be busy. CAP may also be called listen before talk (LBT).
Channel occupancy: transmission(s) on channel(s) from the BS/UE after a CAP.
Channel occupancy time (COT): a total time during which the BS/UE and any BS/UE(s) sharing channel occupancy performs transmission(s) on a channel after a CAP. Regarding COT determination, if a transmission gap is less than or equal to 25 us, the gap duration may be counted in a COT.

The COT may be shared for transmission between the BS and corresponding UE(s).

Specifically, sharing a UE-initiated COT with the BS may mean an operation in which the UE assigns a part of occupied channels through random backoff counter-based LBT (e.g., Category 3 (Cat-3) LBT or Category 4 (Cat-4) LBT) to the BS and the BS performs DL transmission using a remaining COT of the UE, when it is confirmed that a channel is idle by success of LBT after performing LBT without random backoff counter (e.g., Category 1 (Cat-1) LBT or Category 2 (Cat-2) LBT) using a timing gap occurring before DL transmission start from a UL transmission end timing of the UE.

Meanwhile, sharing a gNB-initiated COT with the UE may mean an operation in which the BS assigns a part of occupied channels through random backoff counter-based LBT (e.g., Cat-3 LBT or Cat-4 LBT) to the UE and the UE performs UL transmission using a remaining COT of the BS, when it is confirmed that a channel is idle by success of LBT after performing LBT without random backoff counter (e.g., Cat-1 LBT or Cat-2 LBT) using a timing gap occurring before UL transmission start from a DL transmission end timing of the BS.
DL transmission burst: a set of transmissions without any gap greater than 16 us from the BS. Transmissions from the BS, which are separated by a gap exceeding 16 us are considered as separate DL transmission bursts. The BS may perform transmission(s) after a gap without sensing channel availability within a DL transmission burst.
UL transmission burst: a set of transmissions without any gap greater than 16 us from the UE. Transmissions from the UE, which are separated by a gap exceeding 16 us are considered as separate UL transmission bursts. The UE may perform transmission(s) after a gap without sensing channel availability within a DL transmission burst.
Discovery burst: a DL transmission burst including a set of signal(s) and/or channel(s) confined within a window and associated with a duty cycle. The discovery burst may include transmission(s) initiated by the BS, which includes a PSS, an SSS, and a cell-specific RS (CRS) and further includes a non-zero power CSI-RS. In the NR system, the discover burst includes may include transmission(s) initiated by the BS, which includes at least an SS/PBCH block and further includes a CORESET for a PDCCH scheduling a PDSCH carrying SIB1, the PDSCH carrying SIB1, and/or a non-zero power CSI-RS.

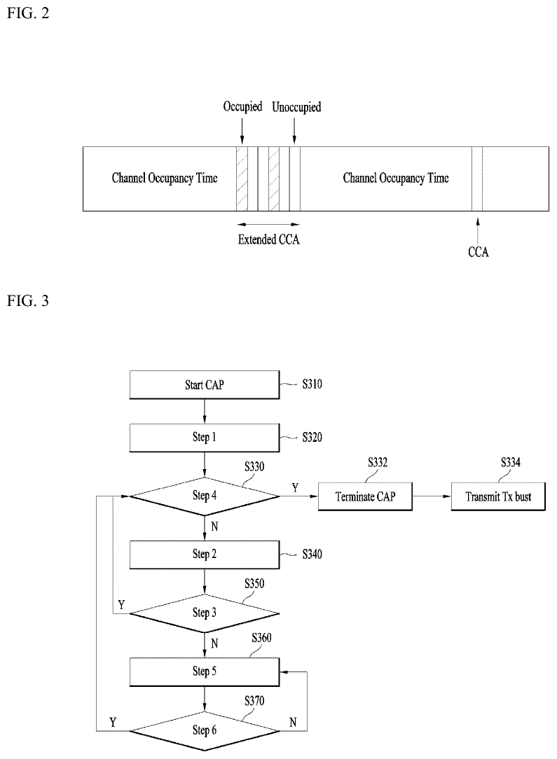

FIG. 2 illustrates an exemplary method of occupying resources in an unlicensed band.

Referring to FIG. 2, a communication node (e.g., a BS or a UE) operating in an unlicensed band should determine whether other communication node(s) is using a channel, before signal transmission. For this purpose, the communication node may perform a CAP to access channel(s) on which transmission(s) is to be performed in the unlicensed band. The CAP may be performed based on sensing. For example, the communication node may determine whether other communication node(s) is transmitting a signal on the channel(s) by carrier sensing (CS) before signal transmission. Determining that other communication node(s) is not transmitting a signal is defined as confirmation of clear channel assessment (CCA). In the presence of a CCA threshold (e.g., Xthresh) which has been predefined or configured by higher-layer (e.g., RRC) signaling, the communication node may determine that the channel is busy, when detecting energy higher than the CCA threshold in the channel. Otherwise, the communication node may determine that the channel is idle. When determining that the channel is idle, the communication node may start to transmit a signal in the unlicensed band. CAP may be replaced with LBT.

Table 1 describes an exemplary CAP supported in NR-U.

TABLE 1

| | Type | Explanation |
|---|---|---|
| DL | Type 1 CAP | CAP with random backoff |
| | | time duration spanned by the sensing slots that |
| | | are sensed to be idle before a downlink |
| | | transmission(s) is random |
| | Type 2 CAP | CAP without random backoff |
| | Type 2A, 2B, 2C | time duration spanned by sensing slots that are |
| | | sensed to be idle before a downlink |
| | | transmission(s) is deterministic |
| UL | Type 1 CAP | CAP with random backoff |
| | | time duration spanned by the sensing slots that |
| | | are sensed to be idle before a downlink |
| | | transmission(s) is random |
| | Type 2 CAP | CAP without random backoff |
| | Type 2A, 2B, 2C | time duration spanned by sensing slots that are |
| | | sensed to be idle before a downlink |
| | | transmission(s) is deterministic |

In a wireless communication system supporting an unlicensed band, one cell (or carrier (e.g., CC)) or BWP configured for a UE may be a wideband having a larger bandwidth (BW) than in legacy LTE. However, a BW requiring CCA based on an independent LBT operation may be limited according to regulations. Let a subband (SB) in which LBT is individually performed be defined as an LBT-SB. Then, a plurality of LBT-SBs may be included in one wideband cell/BWP. A set of RBs included in an LBT-SB may be configured by higher-layer (e.g., RRC) signaling. Accordingly, one or more LBT-SBs may be included in one cell/BWP based on (i) the BW of the cell/BWP and (ii) RB set allocation information. A plurality of LBT-SBs may be included in the BWP of a cell (or carrier). An LBT-SB may be, for example, a 20-MHz band. The LBT-SB may include a plurality of contiguous (P) RBs in the frequency domain, and thus may be referred to as a (P) RB set.

In Europe, two LBT operations are defined: frame based equipment (FBE) and load based equipment (LBE). In FBE, one fixed frame is made up of a channel occupancy time (e.g., 1 to 10 ms), which is a time period during which once a communication node succeeds in channel access, the communication node may continue transmission, and an idle period corresponding to at least 5% of the channel occupancy time, and CCA is defined as an operation of observing a channel during a CCA slot (at least 20 us) at the end of the idle period. The communication node performs CCA periodically on a fixed frame basis. When the channel is unoccupied, the communication node transmits during the channel occupancy time, whereas when the channel is occupied, the communication node defers the transmission and waits until a CCA slot in the next period.

In LBE, the communication node may set q∈{4, 5, . . . , 32} and then perform CCA for one CCA slot. When the channel is unoccupied in the first CCA slot, the communication node may secure a time period of up to (13/32) q ms and transmit data in the time period. When the channel is occupied in the first CCA slot, the communication node randomly selects N∈{1, 2, . . . , q}, stores the selected value as an initial value, and then senses a channel state on a CCA slot basis. Each time the channel is unoccupied in a CCA slot, the communication node decrements the stored counter value by 1. When the counter value reaches 0, the communication node may secure a time period of up to (13/32) q ms and transmit data.

An eNB/gNB or UE of an LTE/NR system should also perform LBT for signal transmission in an unlicensed band (referred to as a U-band for convenience). When the eNB or UE of the LTE/NR system transmits a signal, other communication nodes such as a Wi-Fi node should also perform LBT so as not to cause interference with transmission by the eNB or the UE. For example, in the Wi-Fi standard (801.11ac), a CCA threshold is defined as −62 dBm for a non-Wi-Fi signal and −82 dBm for a Wi-Fi signal. For example, when the non-Wi-Fi signal is received by a station (STA) or an access point (AP) with a power of more than −62 dBm, the STA or AP does not transmit other signals in order not to cause interference.

A UE performs a Type 1 or Type 2 CAP for a UL signal transmission in an unlicensed band. In general, the UE may perform a CAP (e.g., Type 1 or Type 2) configured by a BS, for a UL signal transmission. For example, CAP type indication information may be included in a UL grant (e.g., DCI format 0_0 or DCI format 0_1) that schedules a PUSCH transmission.

In the Type 1 UL CAP, the length of a time period spanned by sensing slots sensed as idle before transmission(s) is random. The Type 1 UL CAP may be applied to the following transmissions.
PUSCH/SRS transmission(s) scheduled and/or configured by BS
PUCCH transmission(s) scheduled and/or configured by BS
Transmission(s) related to random access procedure (RAP)

FIG. 3 illustrates Type 1 CAP among channel access procedures of a UE for UL/DL signal transmission in a U-band applicable to the present disclosure.

First, UL signal transmission in the U-band will be described with reference to FIG. 3.

The UE may sense whether a channel is idle for a sensing slot duration in a defer duration Td. After a counter N is decremented to 0, the UE may perform a transmission (S334). The counter N is adjusted by sensing the channel for additional slot duration(s) according to the following procedure.

Step 1) Set N=Ninit where Ninit is a random number uniformly distributed between 0 and CWp, and go to step 4 (S320).

Step 2) If N>0 and the UE chooses to decrement the counter, set N=N−1 (S340).

Step 3) Sense the channel for an additional slot duration, and if the additional slot duration is idle (Y), go to step 4. Else (N), go to step 5 (S350).

Step 4) If N=0 (Y) (S330), stop CAP (S332). Else (N), go to step 2.

Step 5) Sense the channel until a busy sensing slot is detected within the additional defer duration Td or all slots of the additional defer duration Td are sensed as idle (S360).

Step 6) If the channel is sensed as idle for all slot durations of the additional defer duration Td (Y), go to step 4. Else (N), go to step 5 (S370).

Table 2 illustrates that mp, a minimum CW, a maximum CW, a maximum channel occupancy time (MCOT), and an allowed CW size applied to a CAP vary according to channel access priority classes.

TABLE 2

| Channel | | | | | | |
|---|---|---|---|---|---|---|
| Access | | | | | | |
| Priority | | | | | | allowed |
| Class (p) | mp | CWmin, p | CWmax, p | Tulmcot, p | | CWp sizes |
| 1 | 2 | 3 | 7 | 2 | ms | {3, 7} |
| 2 | 2 | 7 | 15 | 4 | ms | {7, 15} |
| 3 | 3 | 15 | 1023 | 6 or 10 | ms | {15, 31, 63, |
| | | | | | | 127, 255, |
| | | | | | | 511, 1023} |
| 4 | 7 | 15 | 1023 | 6 or 10 | ms | {15, 31, 63, |

127, 255,
511, 1023}

The defer duration Td includes a duration Tf (16 us) immediately followed by mp consecutive slot durations where each slot duration Tsl is 9 us, and Tf includes a sensing slot duration Tsl at the start of the 16-us duration. CWWmin,p<=CWp<=CWmax,p. CWp is set to CWmin,p, and may be updated before Step 1 based on an explicit/implicit reception response to a previous UL burst (e.g., PUSCH) (CW size update). For example, CWp may be initialized to CWmin,p based on an explicit/implicit reception response to the previous UL burst, may be increased to the next higher allowed value, or may be maintained to be an existing value.

In the Type 2 UL CAP, the length of a time period spanned by sensing slots sensed as idle before transmission(s) is deterministic. Type 2 UL CAPs are classified into Type 2A UL CAP, Type 2B UL CAP, and Type 2C UL CAP. In the Type 2A UL CAP, the UE may transmit a signal immediately after the channel is sensed as idle during at least a sensing duration Tshort_dl (=25 us). Tshort_dl includes a duration Tf (=16 us) and one immediately following sensing slot duration. In the Type 2A UL CAP, Tf includes a sensing slot at the start of the duration. In the Type 2B UL CAP, the UE may transmit a signal immediately after the channel is sensed as idle during a sensing slot duration Tf (=16 us). In the Type 2B UL CAP, Tf includes a sensing slot within the last 9 us of the duration. In the Type 2C UL CAP, the UE does not sense a channel before a transmission.

To allow the UE to transmit UL data in the unlicensed band, the BS should succeed in an LBT operation to transmit a UL grant in the unlicensed band, and the UE should also succeed in an LBT operation to transmit the UL data. That is, only when both of the BS and the UE succeed in their LBT operations, the UE may attempt the UL data transmission. Further, because a delay of at least 4 msec is involved between a UL grant and scheduled UL data in the LTE system, earlier access from another transmission node coexisting in the unlicensed band during the time period may defer the scheduled UL data transmission of the UE. In this context, a method of increasing the efficiency of UL data transmission in an unlicensed band is under discussion.

To support a UL transmission having a relatively high reliability and a relatively low time delay, NR also supports CG type 1 and CG type 2 in which the BS preconfigures time, frequency, and code resources for the UE by higher-layer signaling (e.g., RRC signaling) or both of higher-layer signaling and L1 signaling (e.g., DCI). Without receiving a UL grant from the BS, the UE may perform a UL transmission in resources configured with type 1 or type 2. In type 1, the periodicity of a CG, an offset from SFN=0, time/frequency resource allocation, a repetition number, a DMRS parameter, an MCS/TB size (TBS), a power control parameter, and so on are all configured only by higher-layer signaling such as RRC signaling, without L1 signaling. Type 2 is a scheme of configuring the periodicity of a CG and a power control parameter by higher-layer signaling such as RRC signaling and indicating information about the remaining resources (e.g., the offset of an initial transmission timing, time/frequency resource allocation, a DMRS parameter, and an MCS/TBS) by activation DCI as L1 signaling.

The biggest difference between autonomous uplink (AUL) of LTE LAA and a CG of NR is a HARQ-ACK feedback transmission method for a PUSCH that the UE has transmitted without receiving a UL grant and the presence or absence of UCI transmitted along with the PUSCH. While a HARQ process is determined by an equation of a symbol index, a symbol periodicity, and the number of HARQ processes in the CG of NR, explicit HARQ-ACK feedback information is transmitted in AUL downlink feedback information (AUL-DFI) in LTE LAA. Further, in LTE LAA, UCI including information such as a HARQ ID, an NDI, and an RV is also transmitted in AUL UCI whenever AUL PUSCH transmission is performed. In the case of the CG of NR, the BS identifies the UE by time/frequency resources and DMRS resources used for PUSCH transmission, whereas in the case of LTE LAA, the BS identifies the UE by a UE ID explicitly included in the AUL UCI transmitted together with the PUSCH as well as the DMRS resources.

Now, DL signal transmission in the U-band will be described with reference to FIG. 3.

The BS may perform one of the following U-band access procedures (e.g., channel access procedures (CAPs)) to transmit a DL signal in the U-band.

### (1) Type 1 DL CAP Method

In a Type 1 DL CAP, the length of a time duration spanned by sensing slots that are sensed to be idle before transmission(s) is random. The Type 1 DL CAP may be applied to the following transmissions:
(i) transmission(s) initiated by the BS, including (i) a unicast PDSCH with user plane data, or (ii) a unicast PDSCH with user plane data and a unicast PDCCH scheduling the user plane data; or
transmission(s) initiated by the BS, including (i) only a discovery burst, or (ii) a discovery burst multiplexed with non-unicast information.

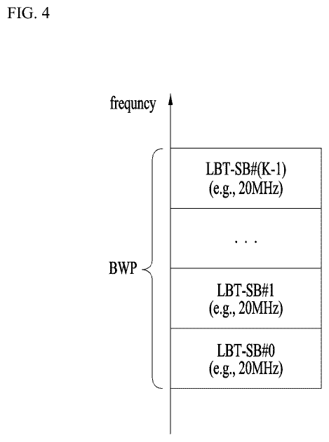

Referring to FIG. 4, the BS may first sense whether a channel is idle for a sensing slot duration of a defer duration Td. Next, if a counter N is decremented to 0, transmission may be performed (S334). The counter N is adjusted by sensing the channel for additional slot duration(s) according to the following procedures.

Step 1) Set N=Ninit where Ninit is a random number uniformly distributed between 0 and CWp, and go to step 4 (S320).

Step 2) If N>0 and the BS chooses to decrement the counter, set N=N−1 (S340).

Step 3) Sense the channel for an additional slot duration, and if the additional slot duration is idle (Y), go to step 4. Else (N), go to step 5 (S350).

Step 4) If N=0 (Y), stop a CAP (S332)). Else (N), go to step 2 (S330).

Step 5) Sense the channel until a busy sensing slot is detected within the additional defer duration Td or all slots of the additional defer duration Td are sensed to be idle (S360).

Step 6) If the channel is sensed to be idle for all slot durations of the additional defer duration Td (Y), go to step 4. Else (N), go to step 5 (S370).

Table 3 illustrates that mp, a minimum CW, a maximum CW, an MCOT, and an allowed CW size, which are applied to a CAP, vary according to channel access priority classes.

TABLE 3

| Channel | | | | | | |
|---|---|---|---|---|---|---|
| Access | | | | | | |
| Priority | | | | | | allowed |
| Class (p) | mp | CWmin, p | CWmax, p | Tmcot, p | | CWp sizes |
| 1 | 1 | 3 | 7 | 2 | ms | {3, 7} |
| 2 | 1 | 7 | 15 | 3 | ms | {7, 15} |
| 3 | 3 | 15 | 63 | 8 or 10 | ms | {15, 31, 63} |
| 4 | 7 | 15 | 1023 | 8 or 10 | ms | {15, 31, 63, |

127, 255,
511, 1023}

The defer duration Td includes a duration Tf (16 us) immediately followed by mp consecutive sensing slot durations where each sensing slot duration Tsl is 9 us, and Tf includes the sensing slot duration Tsl at the start of the 16-us duration.

CWmin,p<=CWp<=CWmax,p. CWp is set to CWmin,p, and may be updated (CW size update) before Step 1 based on HARQ-ACK feedback (e.g., ratio of ACK signals or NACK signals) for a previous DL burst (e.g., PDSCH). For example, CWp may be initialized to CWmin,p based on HARQ-ACK feedback for the previous DL burst, may be increased to the next highest allowed value, or may be maintained at an existing value.

### (2) Type 2 DL CAP Method

In a Type 2 DL CAP, the length of a time duration spanned by sensing slots sensed to be idle before transmission(s) is deterministic. Type 2 DL CAPs are classified into Type 2A DL CAP, Type 2B DL CAP, and Type 2C DL CAP.

The Type 2A DL CAP may be applied to the following transmissions. In the Type 2A DL CAP, the BS may transmit a signal immediately after a channel is sensed to be idle during at least a sensing duration Tshort_dl=25 us. Tshort_dl includes a duration Tf (=16 us) and one immediately following sensing slot duration. Tf includes the sensing slot at the start of the duration.
Transmission(s) initiated by the BS, including (i) only a discovery burst, or (ii) a discovery burst multiplexed with non-unicast information, or
Transmission(s) of the BS after a gap of 25 us from transmission(s) by the UE within shared channel occupancy.

The Type 2B DL CAP is applicable to transmission(s) performed by the BS after a gap of 16 us from transmission(s) by the UE within shared channel occupancy. In the Type 2B DL CAP, the BS may transmit a signal immediately after a channel is sensed to be idle during Tf=16 us. Tf includes a sensing slot within the last 9 us of the duration. The Type 2C DL CAP is applicable to transmission(s) performed by the BS after a maximum of a gap of 16 us from transmission(s) by the UE within shared channel occupancy. In the Type 2C DL CAP, the BS does not sense a channel before performing transmission.

In a wireless communication system supporting a U-band, one cell (or carrier (e.g., CC)) or BWP configured for the UE may consist of a wideband having a larger BW than in legacy LTE. However, a BW requiring CCA based on an independent LBT operation may be limited according to regulations. If a subband (SB) in which LBT is individually performed is defined as an LBT-SB, a plurality of LBT-SBs may be included in one wideband cell/BWP. A set of RBs constituting an LBT-SB may be configured by higher-layer (e.g., RRC) signaling. Accordingly, one or more LBT-SBs may be included in one cell/BWP based on (i) the BW of the cell/BWP and (ii) RB set allocation information.

FIG. 4 illustrates that a plurality of LBT-SBs is included in a U-band.

Referring to FIG. 4, a plurality of LBT-SBs may be included in the BWP of a cell (or carrier). An LBT-SB may be, for example, a 20-MHz band. The LBT-SB may include a plurality of contiguous (P) RBs in the frequency domain and thus may be referred to as a (P) RB set. Although not illustrated, a guard band (GB) may be included between the LBT-SBs. Therefore, the BWP may be configured in the form of {LBT-SB #0 (RB set #0)+GB #0+LBT-SB #1 (RB set #1+GB #1)+ . . . +LBT-SB #(K-1) (RB set (#K-1))}. For convenience, LBT-SB/RB indexes may be configured/defined to be increased as a frequency band becomes higher starting from a low frequency band.

### Listen Before Talk (LBT) Failure Detection and Recovery Procedure

A lower layer (e.g., physical layer) of a UE may perform an LBT procedure for uplink (UL) transmission. When a channel corresponding to the LBT is identified to be occupied, the lower layer does not perform UL transmission. When the lower layer performs the LBT procedure before UL transmission, but transmission is not performed, the lower layer transmits an LBT failure indication to a medium access control (MAC) entity. When the lower layer does not perform LBT, the lower layer does not send an LBT failure indication to the MAC entity.

For example, the MAC entity may detect consistent LBT failure by counting LBT failure indications for all UL transmissions within a corresponding UL BWP for each UL bandwidth (BWP) part. To this end, a maximum counter value and a LBT failure detection timer may be configured from radio resource control (RRC).

When the MAC entity first receives an LBT failure indication from the lower layer, the MAC entity may start the LBT failure detection timer and increase the LBT counter of the first UL BWP related to the LBT failure by 1. Then, whenever the MAC entity receives an LBT failure indication, the MAC entity increases the LBT counter by 1. When the value of the LBT counter is equal to or greater than the maximum counter value before expiration of the corresponding LBT failure detection timer, consistent LBT failure of the first UL BWP may be triggered. When an LBT failure is triggered in SpCell, the UE may change an active UL BWP from a first UL BWP to a second UL BWP. In this case, the second UL BWP may be a UL BWP included in the same carrier as the first UL BWP.

When the UE currently performs a random access procedure through the first UL BWP, the UE may stop and perform a random access procedure through the changed second UL BWP. The UE may report consistent LBT failure to the BS through the MAC CE. When consistent LBT failure is triggered in the first UL BWP and there are multiple UL BWPs to be selected by the UE, the UE may select any one of the multiple UL BWPs and may autonomously select the UL BWP depending on implementation of the UE.

For example, referring to FIG. 5, the UE may perform LBT to perform UL transmission in BWP #1. When the UE fails the LBT for UL transmission in BWP #1 by more than the maximum counter, M, the UE may select one (e.g., BWP #2) of one or more BWPs excluding BWP #1 within the carrier including BWP #1 and attempt LBT in the corresponding BWP, and then perform UL transmission.

When the LBT failure detection timer expires before the value of the LBT counter exceeds the maximum counter value, or all triggered consistent LBT failures are canceled, or the LBT failure detection timer and/or the maximum counter value are reconfigured, the LBT counter value may be reconfigured to 0.

When the UE detects consistent LBT failure in the SCell, the UE may report the consistent LBT failure to the BS. In this case, the UE may report consistent LBT failure through the MAC CE in a serving cell different from the corresponding SCell. When there are no resources available for MAC CE transmission, the UE may report consistent LBT failure through scheduling request (SR).

When the UE detects consistent LBT failure in all UL BWPs for which random access channel (RACH) resources are configured in the PSCell or PCell, the UE may declare radio link failure (RLF).

In an unlicensed band, a channel access procedure such as LBT may be required before transmission. In this case, when LBT fails, transmission may not start. In NR Release-16 NR-U, one UL LBT failure counter is configured, and when the UE fails in UL LBT more than a certain number of times in succession, the LBT failure is reported to a higher layer and a procedure such as UL BWP switching is performed to ensure that there is no ambiguity between the BS and the UE.

In NR Release-17, to support NR in a band above 52.6 GHZ, directional LBT of performing LBT and transmission/reception only in a specific bream direction in addition to omni-directional LBT and omni-directional transmission may be introduced, and thus the UL LBT failure counter may also be defined for each UL signal/channel and/or beam. When the LBT in a specific beam direction for the UE to transmit a specific UL signal/channel continuously fails, there may be a need for a method of performing a procedure such as beam reselection.

A representative channel access procedure performed for transmission in an unlicensed band is listen-before-talk (LBT). This may be a mechanism for preventing collision between transmissions of corresponding signals when an interference level in a surrounding area measured by the BS and/or UE to transmit a signal is compared with a specific threshold such as an ED threshold and a noise level is equal to or less than a certain level.

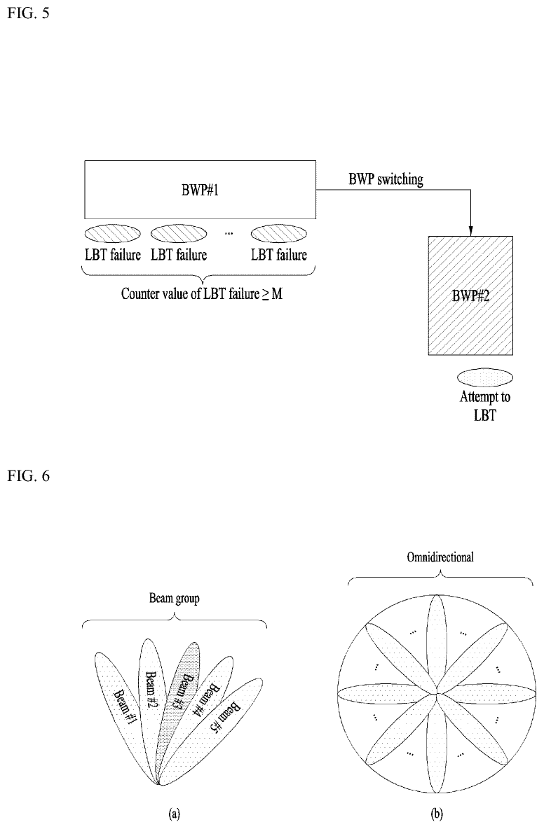

FIG. 6 shows an example of directional LBT and omnidirectional LBT.

(a) of FIG. 6 shows a directional LBT including a specific beam direction LBT and/or a beam group unit LBT, and (b) of FIG. 6 shows an omnidirectional LBT.

In an existing NR-U system (e.g., Rel-16 NR-U), a CAP (i.e., LBT) process is performed, and when a channel is determined to be IDLE, the DL/UL signal/channel is transmitted. In the existing NR-U system, an LBT band is matched with other RATs to ensure coexistence with other RATs (e.g., Wi-Fi), and the CAP (i.e., LBT) is performed in all directions. In other words, the non-directional LBT is performed in the existing NR-U system.

However, in Rel-17 NR-U for transmitting DL/UL signals/channels in a higher band (e.g., 52.6 GHz or higher band) than an unlicensed band of 7 GHz used in the existing NR-U system, directional LBT (D-LBT) for concentrating and transmitting energy in a a specific beam direction may be used to overcome a greater path loss than the existing band of 7 GHZ. In other words, in Rel-17 NR-U, a path loss is reduced through D-LBT, allowing DL/UL signals/channels to be transmitted over wider coverage and also increasing efficiency for coexistence with other RATs (e.g., WiGig).

Referring to (a) of FIG. 6, when a beam group includes beams #1 to beam #5, performing LBT based on beams #1 to #5 may be referred to as a beam group unit LBT. Performing LBT through any one of beams #1 to #5 (e.g., beam #3) may be referred to as specific beam direction LBT. In this case, beams #1 to #5 may be continuous (or adjacent) beams, but may also be discontinuous (or non-adjacent) beams. The number of beams included in a beam group may not necessarily need to be plural, and a single beam may form one beam group.

LBT may be performed for each beam, but LBT may also be performed for each beam group. For example, when LBT is performed for each beam, beams #1 to beams #5 may cover each of a plurality of transmission beams subjected to time domain multiplexing (TDM) and/or spatial domain multiplexing (SDM). For example, beam #1 may cover transmission beam #1 from among a plurality of transmission beams that are time domain multiplexed (TDMed) and/or spatial domain multiplexed (SDMed), beam #2 may cover transmission beam #2 from among the plurality of transmission beams, beam #3 may cover transmission beam #3 from among the plurality of transmission beams, beam #4 may cover transmission beam #4 from among the plurality of transmission beams, and beam #5 may cover transmission beam #5 from among the plurality of transmission beams. Here, cover may mean that an area of a beam for performing LBT includes or is at least the same as an area in which a transmission beam corresponding to the beam has effective influence (or interference).

In other words, this may mean performing energy measurement through a sensing beam for performing LBT that includes an area affected by interference from the transmission beam. It may be possible to determine whether a channel is IDLE/BUSY by comparing the energy measured through the sensing beam with an ED threshold.

As another example, performing LBT for each beam group may mean performing LBT on a beam group basis at once for a plurality of TDM and/or SDM transmission beams corresponding to beams included in the beam group. That is, one beam (hereinafter referred to as a group LBT beam) may be formed for a beam group, and LBT may be performed on all of a plurality of transmission beams at once using a group LBT beam.

Therefore, the group LBT beam may cover all transmission beams (e.g., transmission beam #1 to transmission beam #5) corresponding to the beam group. For example, an area of the group LBT beam may include or at least be the same as all areas in which each of the transmission beams (e.g., transmission beam #1 to transmission beam #5) has an effective influence (or interference).

(b) of FIG. 6 shows omnidirectional LBT and it may be seen that the omnidirectional LBT is performed when one beam group is formed by omni-directional beams and the LBT is performed in units of corresponding beam groups. In other words, when beams in all directions, that is, omni-directional beams, which are a set of beams covering a specific sector in a cell, are included in one beam group, this may mean omnidirectional LBT.

In other words, in the case of a high frequency band, coverage may be limited due to a significant path-loss. To overcome this coverage problem, a multiple antenna scheme may be used. For example, narrow beam transmission, in which energy is concentrated in a specific direction (directionally) to transmit a signal rather than omnidirectional transmission, may be performed.

In a high-frequency unlicensed band, beam-based transmission needs to be combined and considered together with a channel access procedure such as the LBT described above. For example, to perform the directional LBT in a specific direction, transmission may be performed when a channel is determined to be idle by performing directional LBT (D-LBT) only in the corresponding direction or performing LBT in units of beam groups including a beam in the corresponding direction. Here, the beam group may include a single or multiple beams, and when the beam group includes an omni-directional beam, transmission may be expanded to omnidirectional LBT (O-LBT).

Prior to explaining the proposed methods, the NR-based channel access scheme for an unlicensed band applied to the present disclosure may be classified as follows.
Category 1 (Cat-1): Next transmission occurs immediately after a short switching gap immediately after previous transmission ends within the COT, and the switching gap is shorter than a certain length (e.g., 3 us), and a transceiver turnaround time is also included. The Cat-1 LBT may correspond to the type 2C CAP described above.
Category 2 (Cat-2): LBT method without back-off, allowing immediate transmission when a channel is checked to be idle for a certain period of time immediately before transmission. The Cat-2 LBT may be subdivided according to the length of the minimum sensing section required for channel sensing immediately before transmission. For example, the Cat-2 LBT in which the length of the minimum sensing section is 25 us may correspond to the Type 2A CAP described above, and the Cat-2 LBT in which the length of the minimum sensing section is 16 us may correspond to the Type 2B CAP described above. The length of the minimum sensing section is exemplary, and may be shorter than 25 us or 16 us (e.g., 9 us).
Category 3 (Cat-3): LBT method of back-off with a fixed CWS, in which a transmitting entity is capable of performing transmission when a counter value decreases and reaches 0 whenever a random number N is selected within a contention window size (CWS) value (fixed) from 0 to the maximum and a channel is checked to be idle.
Category 4 (Cat-4): LBT method of back-off with variable CWS, in which a transmitting device is capable of performing transmission when a counter value decreases and reaches 0 whenever a random number N is selected within the maximum CWS value (varied) from 0 and a channel is checked to be idle and perform an LBT procedure again by increasing the maximum CWS value to a one level higher value and selecting a random number again within the increased CWS value when receiving feedback from a receiver side that the corresponding transmission is not properly received. The Cat-4 LBT may correspond to the type 1 CAP described above.

In the present disclosure, an LBT procedure for each beam or an LBT procedure for each beam group may basically mean Category-3 (Cat-3) or Category-4 LBT based on random back-off. The LBT for each beam is to perform carrier sensing in a specific beam direction and compares energy measured through the carrier sensing with an ED threshold, and then when the energy measured through carrier sensing is lower than the ED threshold, a channel in a corresponding beam direction is considered to be idle, and when the energy measured through carrier sensing is higher than the ED threshold, the channel in the corresponding direction is determined to be busy.

The beam group LBT procedure is to perform the LBT procedure described above in all beam directions included in the beam group and means that, when there is a beam in a specific direction (e.g., a representative beam) configured/indicated in advance within a beam group, a random back-off based LBT procedure is performed using the corresponding beam as a representative similarly to the multi-CC LBT and that the remaining beams included in the beam group are to perform Category-1 (Cat-1) or Category-2 (Cat-2) and signals are transmitted when the LBT is successful.

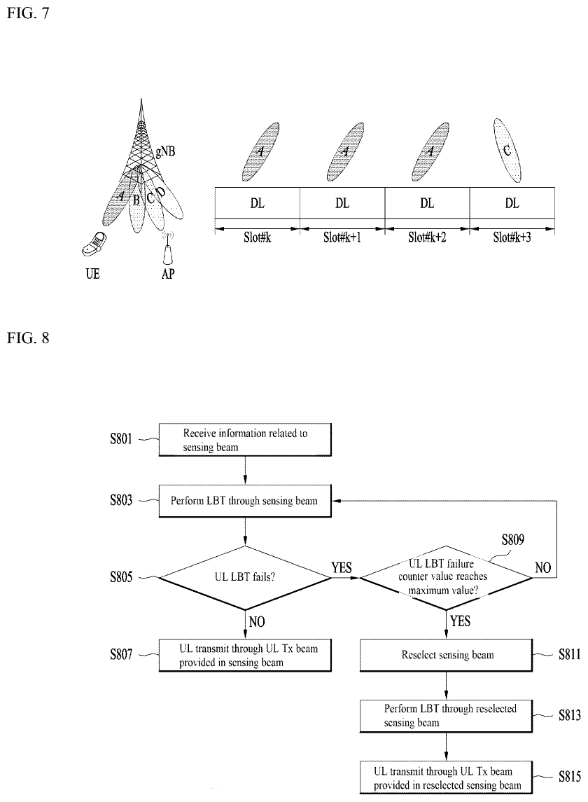

All DL signals/channels (or UL signals/channels) included in one TX burst may be configured into signals/channels with spatial (partial) QCL relationships for the following reasons. For example, as shown in FIG. 7, when the BS transmits a TX burst including a total of 4 slots after successful LBT, the BS may transmit the TX burst in a beam direction A and then transmit the TX burst in a beam C direction in a 4th slot.

However, while the BS transmits a signal in the beam direction A, a Wi-Fi AP coexisting in a corresponding U-band may not detect a signal transmitted in the beam direction A, and thus may determine a channel to be idle, may succeed in LBT, and start transmitting and receiving the signal. In this case, when the BS transmits a signal in the beam direction C starting from slot #k+3, this may interfere with a signal of a corresponding Wi-Fi signal. In this case, the BS transmitting the signal in the beam direction A may cause interference to other coexisting wireless nodes by changing the beam direction and transmitting the signal without additional LBT, and thus a transmission beam direction of a TX burst transmitted after the BS succeeds in LBT may not be changed.

In an NR system, a method of signaling beam information to be used by the UE during UL transmission and reception by associating a DL signal and a UL signal may be considered. For example, when there is a beam direction generated by the UE by associating a channel state information-reference signal (CSI-RS) resources and sounding reference signal (SRS) resources, the UE may transmit a UL signal by using a transmission beam corresponding to a CSI-RS reception beam while transmitting the SRS resource linked with the corresponding CSI-RS resource (or while transmitting a PUSCH scheduled through a UL grant signaled by an SRS resource linked to the corresponding CSI-RS resource). In this case, a relationship between a specific reception beam and a specific transmission beam may be configured by the UE in terms of implementation when the UE has beam correspondence capability. Alternatively, the relationship between a specific reception beam and a specific transmission beam may be established through training between the BS and the UE when the UE does not have beam correspondence capability.

Therefore, when an association relationship between a DL signal and a UL signal is defined, a COT may be allowed to be shared between a DL TX burst including DL signals/channels having a spatial (partial) QCL relationship with the corresponding DL signal and a UL TX burst including UL signals/channels having a spatial (partial) QCL relationship with a UL signal associated with the corresponding DL signal.

Here, the UL signal/channel may include at least one of the following signals/channels.
SRS (sounding RS), DMRS for PUCCH, DMRS for PUSCH, PUCCH, PUSCH, and PRACH

Here, the DL signal/channel may include at least one of the following signals/channels.
Primary synchronization signal (PSS), secondary SS (SSS), DMRS for PBCH, PBCH, tracking reference signal (TRS) or CSI-RS for tracking, CSI-RS for channel state information (CSI) acquisition and CSI-RS for RRM measurement, CSI-RS for beam management, DMRS for PDCCH, DMRS for PDSCH, PDCCH (or a control resource set (CORESET) for transmitting a PDCCH), PDSCH, and the listed signals, or modification of the signal or a newly introduced signal, that is, a signal located before the TX burst and introduced for the purpose of tracking or (fine) time/frequency synchronization or coexistence or power saving or frequency reuse factor=1

The BS may configure spatialrelationinfo for a beam direction to be transmitted by the UE to the UE, or, when the BS supports a Rel-17 unified TCI framework, the BS may indicate a beam direction for UL transmission to the UE through a joint TCI state.

Spatialrelationinfo may include synchronization signal block (SSB)/channel state information-reference signal (CSI-RS)/sounding reference signal (SRS). When SSB/CSI-RS is configured, it may be interpreted as an instruction to use the same beam (same spatial domain filter) as a beam for receiving SSB/CSI-RS when transmission. When the SRS is configured, an instruction may be interpreted as being given to use the same beam as the Tx beam used for SRS transmission as the Tx beam based on the spatialrelationinfo configured for each SRS resource ID when configuring the SRS resource. When a unified TCI state is supported, a beam direction may be indicated through a joint TCI, and in the case of DL/UL separate TCI, the beam direction may be indicated through a UL TCI state. When a specific DL RS is indicated through the joint TCI, this means that a beam corresponding to the corresponding DL RS reception beam may also be used for transmission. For example, when a specific DL RS is indicated through a joint TCI, a beam using the same spatial filter as the DL RS reception beam may also be used in transmission.

Each proposed method described below may be combined and applied together as long as the method does not overlap with other proposed methods.

As described above, in an unlicensed band, implementation of a spectrum sharing mechanism such as LBT may be required before transmission depending on country/region regulations.

When the LBT procedure needs to be performed before channel access, transmission may only be performed when the LBT is successful, and thus unlike the licensed band, when the LBT continues to fail, the UE may not start transmission. For example, when the BS schedules physical uplink shared channel (PUSCH) transmission after instructing the UE to switch UL BWP through a UL grant, if the UE continuously fails in UL LBT in a switched UL BWP after UL BWP switching and does not transmit the PUSCH, the BS may not know whether the UE fails to receive the UL grant, or whether BWP switching is achieved but PUSCH is not transmitted due to LBT failure.

To resolve this problem, Release-16 NR-U configures a UL LBT failure counter, and reports UL LBT failures to a higher layer (e.g., layer 2) whenever the UE fails UL LBT. In case of failure more than a certain number of times in succession, the UE performs a procedure such as UL BWP switching according to the counter value managed by the higher layer and reports this to the BS to remove ambiguity between the BS and the UE.

In Release-17, to support NR in a band above 52.6 GHZ, directional LBT of performing LBT and transmission/reception of signals only in a specific bream direction in addition to omni-directional LBT and omni-directional transmission may be introduced, and thus the UL LBT failure counter needs to be defined for each UL signal/channel and/or beam. Therefore, the present disclosure proposes a method of performing a procedure such as beam reselection and/or BWP switching in case of continuous LBT failure in a specific beam direction for specific UL signal/channel transmission.

FIGS. 8 to 10 are diagrams for explaining the overall operation process of a UE and a BS according to the proposed methods of the present disclosure.

Referring to FIG. 8, the UE may receive information related to a sensing beam (S801) and perform LBT through the corresponding sensing beam (S803). Here, the information related to the sensing beam may be information indicating a sensing beam for performing LBT or may be information indicating a UL Tx beam for performing UL transmission, and the UL Tx beam may be provided in the sensing beam.

When the information related to the sensing beam is information indicating a UL Tx beam, the UE may select a sensing beam including the corresponding UL Tx beam based on the corresponding UL Tx beam.

When the corresponding LBT is successful (S805), the UE may perform UL transmission through the UL Tx beam provided in the corresponding sensing beam (S807). When the LBT fails (S805), the UE may determine whether a UL LBT failure counter value reaches a maximum value (S809), and when the UL LBT failure counter value does not reach the maximum value, the method may return to operation S803 to perform the LBT through the same sensing beam and to perform subsequent procedures.

When the UL LBT failure counter value reaches the maximum value, the UE may reselect the sensing beam (S811). In this case, the reselected sensing beam may be provided in the same UL BWP as a previous sensing beam or may be provided in a different UL BWP from the previous sensing beam. The reselected sensing beam may be provided in the same cell as a previous sensing beam or may be provided in a different cell from the previous sensing beam.

The UE may perform LBT through the reselected sensing beam (S813) and perform UL transmission through a UL Tx beam provided in the reselected sensing beam (S815).

The detailed operation process and operation method of the UE from S801 to S815 in FIG. 8 may be based on at least one of [Method #1] to [Method #3].

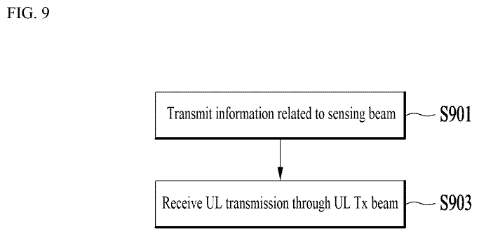

Referring to FIG. 9, the BS may transmit information related to the sensing beam (S901). Here, the information related to the sensing beam may be information indicating a sensing beam for performing LBT or may be information indicating a UL Tx beam for performing UL transmission, and the UL Tx beam may be provided in the sensing beam.

When the information related to the sensing beam is information indicating a UL Tx beam, the UE may select a sensing beam including the corresponding UL Tx beam based on the corresponding UL Tx beam.

The BS may receive UL transmission through the UL Tx beam (S903). In this case, the UL Tx beam may be a UL Tx beam provided in the sensing beam or may be a UL Tx beam provided in a sensing beam reselected by the UE due to continuous LBT failure. The sensing beam related to the information transmitted by the BS and the reselected sensing beam may be provided in the same UL BWP or cell or may be provided in different UL BWPs or cells.

The detailed operation process and operation method of the BS from S901 to S903 in FIG. 9 may be based on at least one of [Method #1] to [Method #3].

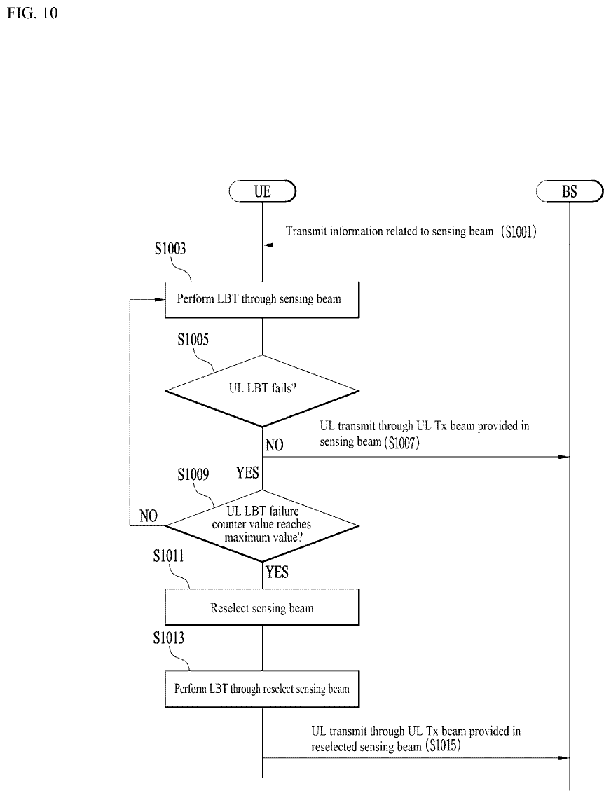

Referring to FIG. 10, the BS may transmit information related to the sensing beam to the UE (S1001). The UE may perform LBT through the corresponding sensing beam (S1003).

Here, the information related to the sensing beam may be information indicating a sensing beam for performing LBT or may be information indicating a UL Tx beam for performing UL transmission, and the UL Tx beam may be provided in the sensing beam.

When the information related to the sensing beam is information indicating a UL Tx beam, the UE may select a sensing beam including the corresponding UL Tx beam based on the corresponding UL Tx beam.

When the corresponding LBT is successful (S1005), the UE may perform UL transmission through the UL Tx beam provided in the corresponding sensing beam (S807). When the LBT fails (S1005), the UE may determine whether a UL LBT failure counter value reaches a maximum value (S1009), and when the UL LBT failure counter value does not reach the maximum value, the method may return to operation S1003 to perform the LBT through the same sensing beam and to perform subsequent procedures.

When the UL LBT failure counter value reaches the maximum value, the UE may reselect the sensing beam (S1011). In this case, the reselected sensing beam may be provided in the same UL BWP as a previous sensing beam or may be provided in a different UL BWP from the previous sensing beam. The reselected sensing beam may be provided in the same cell as a previous sensing beam or may be provided in a different cell from the previous sensing beam.

The UE may perform LBT through the reselected sensing beam (S1013) and perform UL transmission through a UL Tx beam provided in the reselected sensing beam (S1015).

The detailed operation process and operation method of a network from S1001 to S1015 in FIG. 10 may be based on at least one of [Method #1] to [Method #3].

### [Method #1]

(1) Method of linking/configuring UL LBT failure counter value to sensing beam corresponding to UL Tx beam for each UL signal/channel indicated through spatialrelationinfo or unified TCI framework when UL LBT failure counter value is to be configured/indicated and managed for each beam
(2) Method of notifying UL LBT failure from lower layer of UE to higher layer (e.g., layer 2 or MAC layer) whenever UL LBT failure occurs and triggering sensing beam reselection procedure or BWP switching/cell reselection procedure when UL LBT failure counter value managed by higher layer reaches preset M value (e.g., maximum LBT failure counter value)

The maximum value M of the UL LBT failure counter configured for each specific beam direction may be configured differently for each beam direction. For example, a sensing beam linked to SSB index 1 may be linked to M1, and a sensing beam linked to SSB index 2 may be linked to M2.

Whether to trigger a sensing beam reselection procedure or a BWP switching/cell reselection procedure after a UL LBT failure counter value linked/configured to a beam reaches the maximum value and this is reported to a higher layer (e.g., MAC layer or layer 2) may be defined in the standard or predefined. For example, when the UL LBT failure counter value linked to the lowest SSB index reaches the maximum value or when the UL LBT failure counter values linked to a specific SSB index(s) all reach the maximum value, the sensing beam reselection procedure or the BWP switching/cell reselection procedure may be defined in the standard or predefined to be triggered.

In the existing Release-16 NR-U, one UL LBT failure counter value is operated by considering all UL transmissions at once not by UL signal/channel, but in the high-frequency unlicensed band, UL Tx beam directions transmitted for respective UL signals/channels may be different, and thus it may be considered that the UL LBT failure counter value is also configured/instructed and managed for each beam.

For example, the UL LBT failure counter value is assumed to be configured/instructed and managed for each SSB index. When the LBT for msg1/msgA transmission corresponding to each SSB index fails, only the UL LBT failure counter value corresponding to the SSB index may be increased. Alternatively, occurrence of a UL LBT failure event for UL transmission linked to the corresponding SSB index may be reported to a higher layer (e.g., MAC layer or layer 2).

The UL Tx beam, which is a direction of a transmission beam for each UL signal/channel, may be configured/instructed through spatialrelationinfo or unified TCI framework. The sensing beam used to perform LBT for transmission of the corresponding UL Tx beam may be the same as or different from the corresponding UL Tx beam depending on the beam correspondence (BC) capability of the UE. However, basically, the sensing beam for transmitting a specific UL Tx beam needs always to be provided in a specific UL Tx beam. In other words, the sensing beam needs to be configured/directed to cover an interference area affected by UL Tx beam transmission. Therefore, the UL LBT failure counter for each beam direction may be configured for each UL Tx beam direction or may be configured for each sensing beam direction.

A UL LBT failure counter configured for each beam may be linked with each UL signal/channel. For example, a UL Tx beam used for each UL signal/channel transmission is configured/instructed through a specific reference signal (RS) of spatialrelationinfo or the unified TCI framework, and thus a beam direction indicated by the corresponding RS may be linked with a UL LBT failure counter.

For example, when a specific CSI-RS is indicated through spatialrelationinfo, the UL Tx beam of a UE with BC capability={1} (i.e., UE with BC capability) may be configured to be the same as or correspond to the corresponding CSI-RS Rx beam. In this case, for example, a spatial domain filter used when receiving the corresponding CSI-RS may also be used during UL transmission.

As another example, when a specific DL RS is configured through a joint TCI state for a PUSCH Tx beam of a UE with BC capability={1} (i.e., UE with BC capability), a beam that is the same as or corresponds to the corresponding DL RS Rx beam may be used as a UL Tx beam, and a UL LBT failure counter may be linked to the same sensing beam as the UL Tx beam, and thus the UL LBT failure counter value may be managed (e.g., increased) depending on whether the UL LBT fails. In the above, BC capability={1} may mean beamCorrespondence WithoutUL-BeamSweeping={1}.

For example, when information such as SSB index/CSI-RS index/SRS resource indicator (SRI) configured with spatialrelationinfo or a joint TCI state index of Rel-17 unified TCI framework is indicated to the UE for configuring a UL Tx beam, UL LBT failure may be reported to a higher layer (e.g., MAC layer or layer 2) whenever the UL LBT failure counter is configured for each indicated SSB index/CSI-RS index/SRI/joint TCI state index (UL TCI state index in the case of separate DL/UL) and the LBT in the corresponding beam direction fails.

Alternatively, when the UL LBT failure counter is configured/indicated for each SSB index, if the SSB index is indicated for a specific UL signal/channel through spatialrelationinfo, a UL LBT failure counter value configured/indicated for the corresponding SSB index may correspond to the UL signal/channel.

When a specific RS (QCL target) is indicated through spatialrelationinfo/unified TCI framework for each UL signal/channel, the UL signal/channel and the SSB index may be matched to each other through a relationship between QCL top sources (e.g., SSB index configured as QCL top source). Through this method, the UL LBT failure counter configured/indicated in the SSB index may be matched to each UL signal/channel.

The QCL top source means the last configured QCL source RS when the QCL RS of the TCI state connected to CORESET is another DL RS (e.g., CSI-RS or tracking reference signal (TRS)) other than SSB, a QCL RS in a TCI state, connected to the corresponding QCL RS, and the connected QCL RS is continuously tracked. For example, when the QCL RS of the DMRS is configured to a CSI-RS, the QCL RS of the CSI-RS is configured to a TRS, and when the QCL RS of the TRS is configured to a SSB, the QCL top source of the DMRS is an SSB that is a QCL of the TRS.

For example, when a specific CSI-RS is configured/instructed through spatialrelationinfo to configure/instruct a PUSCH UL Tx beam to the UE, one SSB index may correspond to a specific CSI-RS through a relationship with the QCL top source (e.g., Type-C or Type-D QCL source SSB), and through this, the UL LBT failure counter value configured in the corresponding UL signal/channel and SSB index may be matched to each other.

In Release-16 NR-U, whenever a UL LBT failure occurs, this may be reported to a higher layer (e.g., MAC layer or layer 2) and a UL LBT failure counter value managed by the higher layer (e.g., MAC layer or layer 2) reaches a certain value, a trigger for UL BWP switching may be induced in the case of an RRC connected UE, and a trigger for cell reselection may be induced in the case of a UE in an idle mode.

However, in Release-17 NR operating in a high-frequency unlicensed band, the UL LBT failure counter may be configured/indicated and managed for each beam as described above, and thus whenever a UL LBT failure configured for each beam occurs, UL LBT failure may be notified to a higher layer (e.g., MAC layer or layer 2). When the UL failure counter value managed by the higher layer (e.g., MAC layer or layer 2) reaches a preset M value, a method of reselecting a corresponding sensing beam as another beam (i.e., another sensing beam) instead of a method of triggering the BWP switching/cell reselection procedure may be considered.

In this case, the maximum value M of the UL LBT failure counter configured for each specific beam direction may be configured differently for each beam direction. For example, a beam linked to SSB index 1 may be linked to M1, and a beam linked to SSB index 2 may be linked to M2.

When the UL LBT failure counter value linked/configured to the beam reaches the maximum value, whether to trigger a sensing beam reselection procedure or a BWP switching/cell reselection procedure may be defined in the standard or predefined. For example, when the UL LBT failure counter value linked to the lowest SSB index reaches the maximum value or when the UL LBT failure counter values linked to a specific SSB index(s) all reach the maximum value, the sensing beam reselection procedure or the BWP switching/cell reselection procedure may be defined in the standard or predefined to be triggered.

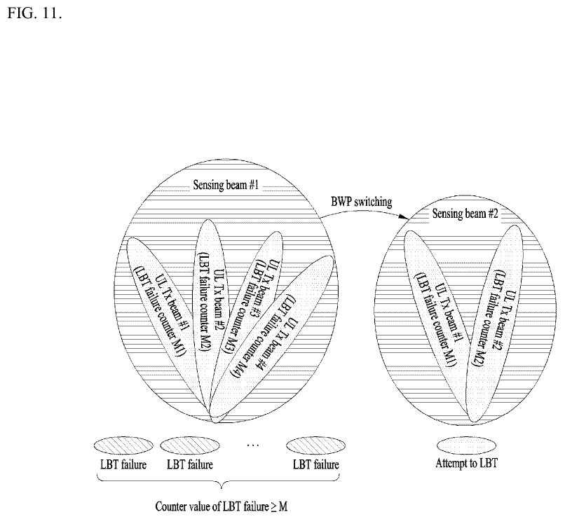

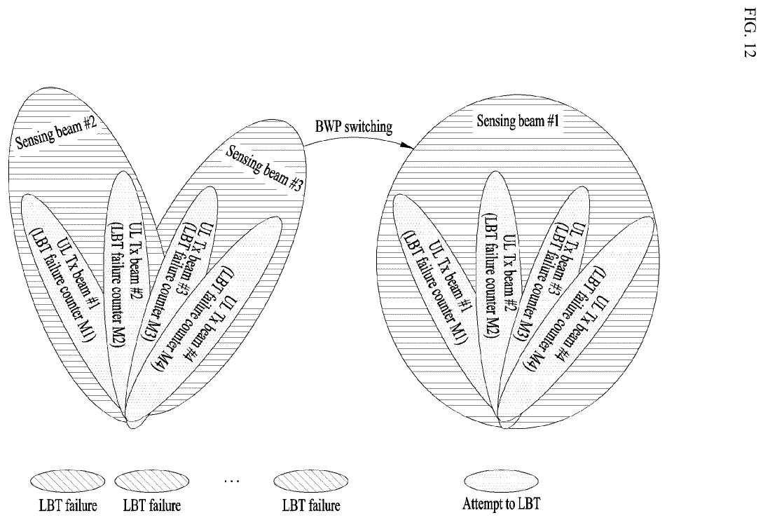

For example, referring to FIG. 11, when the UE intends to perform UL transmission through UL Tx beam #1, the UE may select sensing beam #1 including UL Tx beam #1 to UL Tx beam #4 and perform LBT. However, when the UL LBT according to sensing beam #1 continues to fail and the maximum UL LBT failure counter value reaches M, the UE may reselect sensing beam #2, which includes only UL Tx beam #1 and UL Tx beam #2, and perform the UL LBT. However, depending on implementation of the UE, a sensing beam that includes only UL Tx beam #1 or is the same as UL Tx beam #1 may be reselected, and which sensing beam to reselect may depend on implementation of the UE.

The above-described example may be more efficient than BWP reselection or cell reselection. That is, when the UE reselects a BWP or reselects a cell, the UE needs to inform the BS of this to remove ambiguity for a frequency resource on which UL transmission is performed between the UE and the BS.

However, as described above, when a sensing beam is reselected, the UE does not necessarily have to provide information about a sensing beam reselected by the BS. In UL transmission, when the BS instructs to use UL Tx beam #1 and both a sensing beam that fails in UL LBT and a sensing beam that succeeds in UL LBT through reselection include UL Tx beam #1, UL transmission may be eventually performed with the UL Tx beam #1 instructed by the BS. Then, in terms of the BS, it may not be important which sensing beam is used. In other words, in terms of the BS, UL transmission only needs to be received through UL Tx beam #1, and when UL transmission is performed through the UL Tx beam indicated by the BS, there is no ambiguity between the UE and the BS, and thus additional reporting for the sensing beam used by the UE may not need to be performed.

A time required to reselect a sensing beam may be relatively short compared to BWP reselection or cell reselection. Therefore, in the case of sensing beam reselection, channel access may be successfully achieved through a relatively short delay time compared to BWP reselection or cell reselection, and UL transmission may be performed.

However, when any sensing beam including UL Tx beam #1 is not suitable for performing UL LBT, the UE may reselect a sensing beam that does not include UL Tx beam #1 and perform UL transmission through a UL Tx beam provided in the corresponding sensing beam. In this case, the UE may report information about the UL Tx beam used for UL transmission to the BS through the corresponding UL transmission or separate UL transmission.

### [Method #2]

(1) Method of linking/configuring LBT failure counter value to sensing beam corresponding to UL Tx beam for each UL signal/channel indicated through N UL LBT failure counters and spatialrelationinfo or unified TCI framework, and
(2) Method of triggering sensing beam reselection procedure or BWP switching/cell reselection procedure when UL LBT failure counter value reaches preset value M

In this case, the number N of UL LBT failure counters may be defined in the standard or preset, and the maximum value M of each UL LBT failure counter may be configured differently for each UL LBT counter. For example, UL LBT failure counter #1 may be configured as M1, and UL LBT failure counter #2 may be configured as M2.

Whenever a UL LBT failure occurs, the UE may notify the UL LBT failure from the lower layer (e.g., physical layer) of the UE to the higher layer (e.g., MAC layer or layer 2). When the UL LBT failure counter value managed by the higher layer (e.g., MAC layer or layer 2) reaches the preset value M, whether to trigger the sensing beam reselection procedure or the BWP switching/cell reselection procedure may be defined in the standard or predefined. For example, when the UL LBT failure counter value linked to the lowest SSB index reaches the maximum value or when the UL LBT failure counter values linked to a specific SSB index(s) all reach the maximum value, the sensing beam reselection procedure or the BWP switching/cell reselection procedure may be defined in the standard or predefined to be triggered.

In [Method #1], a UL LBT failure counter may be configured/instructed and managed for each SSB index, and when a UL Tx beam and a sensing beam are indicated through a specific RS of spatialrelationinfo or a specific RS for each UL signal/channel, the UL signal/channel and the SSB index may be matched to each other through a SSB that is a QCL top source of the corresponding RS and the UL LBT failure counter value may be configured/indicated.

On the other hand, [Method #2] is a method in which, when N UL LBT failure counters are configured, the UL LBT failure counter value is managed for each UL signal/channel by matching each UL LBT failure counter with a UL signal/channel. The QCL top source means the last configured QCL source RS when the QCL RS of the TCI state connected to CORESET is another DL RS (e.g., CSI-RS or tracking reference signal (TRS)) other than SSB, a QCL RS in a TCI state, connected to the corresponding QCL RS, and the connected QCL RS is continuously tracked. For example, when the QCL RS of the DMRS is configured to a CSI-RS, the QCL RS of the CSI-RS is configured to a TRS, and when the QCL RS of the TRS is configured to a SSB, the QCL top source of the DMRS is an SSB that is a QCL of the TRS.

Similar to [Method #1], when information about a UL Tx beam is configured with spatialrelatioininfo or unified TCI framework of a specific UL signal/channel, which UL LBT failure counter and UL Tx beam are linked from among the N preset UL LBT failure counters may be explicitly configured.

For example, the UL Tx beam used for each UL signal/channel transmission may be configured/indicated through a specific RS of spatialrelationinfo or unified TCI framework (e.g., UL TCI state index in the case of SSB index/CSI-RS index/SRI or joint TCI state index). Therefore, when the specific RS is configured, the UL LBT failure counter corresponding to the specific RS may be configured.

For example, when N UL LBT failure counters are configured, connection to UL LBT failure counter #1 may be configured when configuring for SRS resource index #0, and connection to UL LBT failure counter #4 may be configured when configuring for SRS resource index #1. Then, when LBT fails while attempting to transmit UL such as SRS/PUSCH connected to SRS resource index #0, it may be reported that an LBT failure for UL LBT failure counter #1 event occurs to a higher layer (e.g., MAC layer or layer 2) each time there is a failure.

Like [Method #1], the UL LBT failure counter may be configured/indicated and managed for each beam, and thus whenever a UL LBT failure configured for each beam occurs, the higher layer (e.g., MAC layer or layer 2) UL LBT failure may be reported. When the UL failure counter value managed by the higher layer (e.g., MAC layer or layer 2) reaches a preset M value, a method of reselecting a corresponding sensing beam as another beam (i.e., another sensing beam) instead of a method of triggering the BWP switching/cell reselection procedure may be considered. In this case, the maximum value M of the UL LBT failure counter configured for each specific beam direction may be configured differently for each beam direction. For example, a beam linked to SSB index 1 may be linked to M1, and a beam linked to SSB index 2 may be linked to M2.

When the UL LBT failure counter value linked/configured to the beam reaches the maximum value, whether to trigger a sensing beam reselection procedure or a BWP switching/cell reselection procedure may be defined in the standard or predefined. For example, when the UL LBT failure counter value linked to the lowest SSB index reaches the maximum value or when the UL LBT failure counter values linked to a specific SSB index(s) all reach the maximum value, the sensing beam reselection procedure or the BWP switching/cell reselection procedure may be defined in the standard or predefined to be triggered.

For example, referring to FIG. 11, UL Tx beam #1 may be linked to the UL LBT failure counter M1, UL Tx beam #2 may be linked to the UL LBT failure counter M2, UL Tx beam #3 may be linked to the UL LBT failure counter M3, and UL Tx beam #4 may be linked to the UL LBT failure counter M4. The UL LBT failure counters M1/M2/M3/M4 may be linked to SSB index #0 (i.e., sensing beam #1), and the UL LBT failure counters M1/M2 may be linked to SSB index #1 (i.e., sensing beam #2).

In this case, while the UE performs UL LBT for UL Tx beam #1 to UL Tx beam #4 through sensing beam #1, when UL LBT fails, the counter may be increased for each UL Tx beam. When the number of UL LBT failures of UL Tx beam #1 to UL Tx beam #4 all reach M1 to M4, respectively, due to a UL LBT failure, UL LBT may be performed again by changing the sensing beam to sensing beam #2.

As another example, referring to FIG. 12, when the UL LBT failure counters M1/M2 are linked to SSB index #1 (i.e., sensing beam #2), and UL LBT failure counters M3/M4 are linked to SSB index #2 (i.e., sensing beam #3) covering UL Tx beams #3/#4, if UL LBT failure according to sensing beam #2 linked to a lower SSB index (i.e. SSB index #1) of two sensing beams reaches M1 and/or M2 during simultaneous attempt of UL LBT through sensing beam #2 and sensing beam #3 to transmit UL Tx beams #1 to #4, the UE may reselect other sensing beam(s) (e.g., sensing beam #1) excluding beam #2 and sensing beam #3 and may also perform UL LBT.

[Method #3] Method of liking UL LBT failure counters between preconfigured/defined beams and managing the same according to inclusion relationship between beams when UL LBT failure counter value is configured/indicated for each beam direction corresponding to SSB index and for each beam direction corresponding to specific RS indicated through spatialrelationinfo/unified TCI framework and is separately managed

For example, when LBT fails for a specific UL signal in a state in which a UL LBT counter index linked to each UL signal is preset through [Method #1] or [Method #2], whether to increase only the UL LBT failure counter value for the UL LBT counter index linked to the corresponding UL signal (i.e., the UL LBT failure counter is managed independently) or whether to additionally increase the UL LBT failure counter value for the LBT counter index linked to the SSB index corresponding to a QCL top source of the corresponding UL signal (i.e., the UL LBT failure counters are managed in conjunction with each other) may be preconfigured by the BS or defined in the standard.

In [Method #1], when the UL LBT failure counter value is configured/indicated for each SSB index, the UL Tx beam and the sensing beam may be indicated through UL signal/channel or a specific RS of spatialrelationinfo or unified TCI framework for each UL signal/channel. The UL LBT failure counter value may be configured/indicated by matching the UL signal/channel and the SSB index through SSB, which is the QCL top source of the corresponding RS. That is, the UL LBT failure counter value may be configured/indicated for each sensing beam corresponding to the SSB index.

In [Method #2], when N UL LBT failure counters are configured, each UL LBT failure counter may be matched with a UL signal/channel to manage the UL LBT failure counter value for each UL signal/channel or UL LBT counter index. The QCL top source means the last configured QCL source RS when the QCL RS of the TCI state connected to CORESET is another DL RS (e.g., CSI-RS or tracking reference signal (TRS)) other than SSB, a QCL RS in a TCI state, connected to the corresponding QCL RS, and the connected QCL RS is continuously tracked. For example, when the QCL RS of the DMRS is configured to a CSI-RS, the QCL RS of the CSI-RS is configured to a TRS, and when the QCL RS of the TRS is configured to a SSB, the QCL top source of the DMRS is an SSB that is a QCL of the TRS.

Therefore, the BS may configure/indicate the UL LBT failure counter value for each beam direction (e.g., sensing beam) corresponding to the SSB index or for each beam direction (e.g., UL Tx beam) indicated through a specific RS of spatialrelationinfo/unified TCI framework depending on the granularity of a beam in which the UL LBT failure counter value is to be configured/indicated. In this case, the QCL top source in a beam direction corresponding to a specific RS for which the UL LBT failure counter is configured may correspond to a specific SSB index. Accordingly, the UL LBT failure counter value configured in the beam direction corresponding to the SSB index and the UL LBT failure counter value configured in the beam direction corresponding to a specific RS may affect each other.

Thus, when LBT fails for a specific UL signal in a state in which a UL LBT counter index linked to each UL signal is preset through [Method #1] or [Method #2], whether to increase only the UL LBT failure counter value for the UL LBT counter index linked to the corresponding UL signal (i.e., the UL LBT failure counter is managed independently) or whether to additionally increase the UL LBT failure counter value for the LBT counter index linked to the SSB index corresponding to a QCL top source of the corresponding UL signal (i.e., the UL LBT failure counters are managed in conjunction with each other) may be preconfigured by the BS or defined in the standard. For example, when UL LBT failure counters are configured to influence each other, if a specific UL signal is linked to CSI-RS index #1 and it is known that the UL LBT fails through a higher layer (e.g., MAC layer or layer 2) whenever UL LBT fails, not only the UL LBT failure counter value linked to the corresponding UL signal may be increased, but also the UL LBT failure counter value linked to the SSB index, which is the top QCL source of the corresponding CSI-RS index, may be increased together.

For example, referring to FIG. 11, UL LBT failure counter values M1 to M4 are configured in UL Tx beam #1 to UL Tx beam #4, respectively, LBT failure counter value M is configured in sensing beam #1, and SSB index #0 corresponding to sensing beam #1 is assumed to be a top QCL resource of UL Tx beam #1 to UL Tx beam #4. In this case, when the LBT for sensing beam #1 of the UE for UL transmission through UL Tx beam #1 fails, a counter value of M1 linked to UL Tx beam #1 may be increased and at the same time, and the counter value of M for sensing beam #1 may also be increased. Then, when the LBT for sensing beam #1 of the UE for UL transmission through UL Tx beam #2 fails, a counter value of M2 linked to UL Tx beam #2 may be increased and at the same time, and the counter value of M for sensing beam #1 may also be increased again. In this way, when M reaches the maximum value, even if M1 to M4 do not reach the maximum value, the UE may reselect the sensing beam as sensing beam #2 and perform LBT again based on sensing beam #2.

The content of the present disclosure may be used not only in uplink and/or downlink, but also in direct communication between UEs, and in this case, the proposed method may be used in a BS or a relay node.

It is obvious that the examples of the proposed method described above may also be included as one of the implementation methods of the present disclosure, and thus may be regarded as a type of proposed method. The proposed methods described above may be implemented independently, but may also be implemented in the form of a combination (or merge) of some of the proposed methods. A rule may be defined to provide information on whether the proposed methods are applied (or information about the rules of the proposed methods) by transmitting a predefined signal (e.g., a physical layer signal or a higher layer signal) from the BS to the UE or from a transmitting UE to a receiving UE.

The various descriptions, functions, procedures, proposals, methods, and/or operation flowcharts of the present disclosure described herein may be applied to, but not limited to, various fields requiring wireless communication/connectivity (e.g., 5G) between devices.

More specific examples will be described below with reference to the drawings. In the following drawings/description, like reference numerals denote the same or corresponding hardware blocks, software blocks, or function blocks, unless otherwise specified.

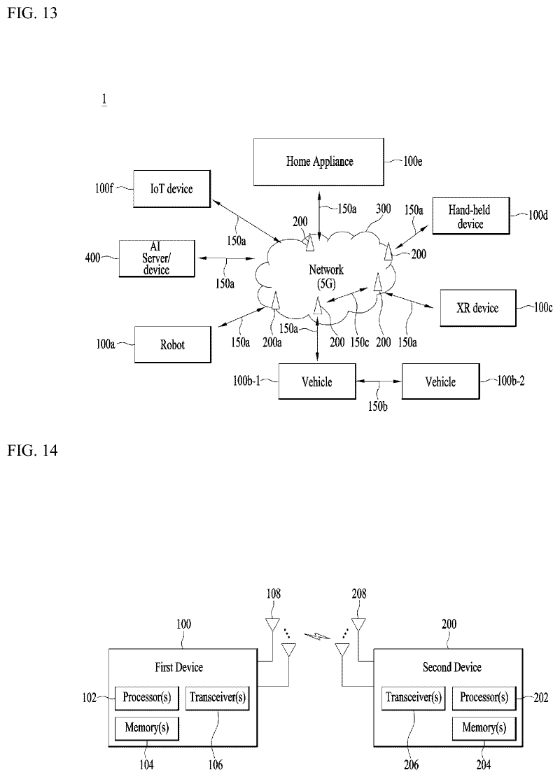

FIG. 13 illustrates a communication system 1 applied to the present disclosure.

Referring to FIG. 13, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smartpad, a wearable device (e.g., a smartwatch or smartglasses), and a computer (e.g., a laptop). The home appliance may include a TV, a refrigerator, a washing machine, and so on. The IoT device may include a sensor, a smartmeter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g. V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g. relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

FIG. 14 illustrates wireless devices applicable to the present disclosure.

Referring to FIG. 14, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 13.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

Specifically, instructions and/or operations, controlled by the processor 102 of the first wireless device 100 and stored in the memory 104 of the first wireless device 100, according to an Embodiment of the present disclosure will be described.

Although the following operations will be described based on a control operation of the processor 102 in terms of the processor 102, software code for performing such an operation may be stored in the memory 104. For example, in the present disclosure, the at least one memory 104 may be a computer-readable storage medium and may store instructions or programs. The instructions or programs may cause, when executed, the at least one processor operably connected to the at least one memory to perform operations according to Embodiments or implementations of the present disclosure, related to the following operations.

For example, the processor 102 may receive information related to a sensing beam through the transceiver 106 and perform LBT through the corresponding sensing beam. Here, the information related the sensing beam may be information indicating a sensing beam for performing LBT, or may be information indicating a UL Tx beam for performing UL transmission, and the UL Tx beam may be included in the sensing beam.

When the information related to the sensing beam is information indicating a UL Tx beam, the processor 102 may select a sensing beam including the corresponding UL Tx beam based on the corresponding UL Tx beam.

When the LBT is successful, the processor 102 may perform UL transmission through the transceiver 106 through the UL Tx beam provided in the corresponding sensing beam. When the LBT fails, the processor 102 may determine whether a UL LBT failure counter value reaches a maximum value, and when the UL LBT failure counter value does not reach the maximum value, LBT may be continuously performed again through the same sensing beam, and then a procedure may be performed again.

When the UL LBT failure counter value reaches the maximum value, the processor 102 may reselect the sensing beam (S811). In this case, the reselected sensing beam may be provided in the same UL BWP as a previous sensing beam or may be provided in a different UL BWP from the previous sensing beam. The reselected sensing beam may be provided in the same cell as a previous sensing beam or may be provided in a different cell from the previous sensing beam.

The processor 102 may perform LBT through the reselected sensing beam and perform UL transmission through the transceiver 106 through the UL Tx beam provided in the reselected sensing beam.

The detailed operation process and operation method of the processor 102 described above may be based on at least one of [Method #1] to [Method #3].

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Specifically, instructions and/or operations, controlled by the processor 202 of the second wireless device 100 and stored in the memory 204 of the second wireless device 200, according to an Embodiment of the present disclosure will be described.

Although the following operations will be described based on a control operation of the processor 202 in terms of the processor 202, software code for performing such an operation may be stored in the memory 204. For example, in the present disclosure, the at least one memory 204 may be a computer-readable storage medium and may store instructions or programs. The instructions or programs may cause, when executed, the at least one processor operably connected to the at least one memory to perform operations according to Embodiments or implementations of the present disclosure, related to the following operations.

For example, the processor 202 may transmit information related to the sensing beam through the transceiver 206. Here, the information related the sensing beam may be information indicating a sensing beam for performing LBT, or may be information indicating a UL Tx beam for performing UL transmission, and the UL Tx beam may be included in the sensing beam.

When the information related to the sensing beam is information indicating a UL Tx beam, the UE may select a sensing beam including the corresponding UL Tx beam based on the corresponding UL Tx beam.

The he processor 202 may receive UL transmission by the transceiver 206 through the UL Tx beam. In this case, the UL Tx beam may be a UL Tx beam provided in the sensing beam or may be a UL Tx beam provided in a sensing beam reselected by the UE due to continuous LBT failure. The sensing beam related to the information transmitted by the processor 202 and the reselected sensing beam may be provided in the same UL BWP or cell or may be provided in different UL BWPs or cells.

The detailed operation process and operation method of the processor 202 described above may be based on at least one of [Method #1] to [Method #3].

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

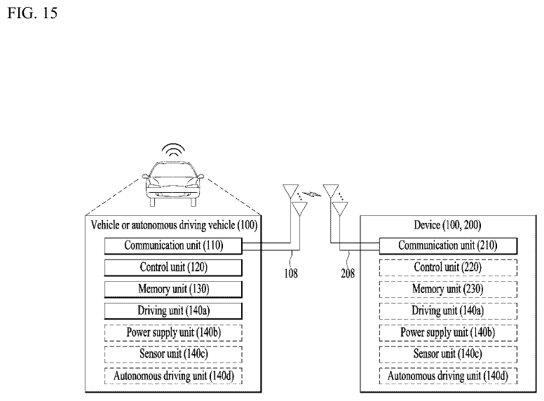

FIG. 15 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 15, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

The Embodiments of the present disclosure described herein below are combinations of elements and features of the present disclosure. The elements or features may be considered selective unless otherwise mentioned. Each element or feature may be practiced without being combined with other elements or features. Further, an Embodiment of the present disclosure may be constructed by combining parts of the elements and/or features. Operation orders described in Embodiments of the present disclosure may be rearranged. Some constructions of any one Embodiment may be included in another Embodiment and may be replaced with corresponding constructions of another Embodiment. It will be obvious to those skilled in the art that claims that are not explicitly cited in each other in the appended claims may be presented in combination as an Embodiment of the present disclosure or included as a new claim by a subsequent amendment after the application is filed.

In the present disclosure, a specific operation described as performed by the BS may be performed by an upper node of the BS in some cases. Namely, it is apparent that, in a network comprised of a plurality of network nodes including a BS, various operations performed for communication with an MS may be performed by the BS, or network nodes other than the BS. The term ‘BS’ may be replaced with the term ‘fixed station’, ‘Node B’, ‘enhanced Node B (eNode B or eNB)’, ‘access point’, etc.

Those skilled in the art will appreciate that the present disclosure may be carried out in other specific ways than those set forth herein without departing from the spirit and essential characteristics of the present disclosure. The above Embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

The method of transmitting and receiving an uplink signal and the device therefor as described above have been explained focusing on the example of application to a 5th generation NewRAT system, but it is possible to apply the method and the device to various wireless communication systems in addition to the 5th generation NewRAT system.

1. A method of performing uplink (UL) transmission by a user equipment (UE) in a wireless communication system, the method comprising:
performing first listen before talk (LBT) based on a first sensing beam from among a plurality sensing beams;
transmitting an LBT failure indication to a medium access control (MAC) entity based on failure of the first LBT;
counting a number of the transmitted LBT failure indications due to consistent failure of the first LBT by the MAC entity;
based on that the number of the LBT failure indications reaches a maximum counter value related to the first sensing beam, selecting a second sensing beam different from the first sensing beam from among the plurality of sensing beams;
performing second LBT based on the second sensing beam; and
based on success of the second LBT, performing the UL transmission through a transmission beam covered by the second sensing beam,
wherein maximum counter values related to the plurality of sensing beams are separately related to the plurality of sensing beams, respectively.

2. The method of claim 1, wherein the first sensing beam is related to a specific synchronization signal block (SSB) index.

3. The method of claim 2, wherein, based on the failure of the first LBT, the number of LBT failure indications related to the third sensing beam related to the specific SSB index is also counted.

4. The method of claim 1, wherein the first sensing beam covers a transmission beam known by spatial relation information or a unified transmission configuration indicator (TCI) framework.

5. The method of claim 4, wherein, based on the failure of the first LBT, both a first LBT failure counter value related to the transmission beam and the second LBT failure counter value related to the first sensing beam are counted.

6. The method of claim 5, wherein the second sensing beam is selected based on at least one of the first LBT failure counter value reaching a first maximum value and the second LBT failure counter value reaching a second maximum value.

7. A user equipment (UE) for performing uplink (UL) transmission in a wireless communication system, the UE comprising:
at least one transceiver;
at least one processor; and
at least one computer memory operatively connected to the at least one processor and configured to store instructions that when executed causes the at least one processor to perform operations including:
performing first listen before talk (LBT) based on a first sensing beam from among a plurality sensing beams;
transmitting an LBT failure indication to a medium access control (MAC) entity based on failure of the first LBT;
counting a number of the transmitted LBT failure indications due to consistent failure of the first LBT by the MAC entity;
based on that the number of the LBT failure indications reaches a maximum counter value related to the first sensing beam, selecting a second sensing beam different from the first sensing beam from among the plurality of sensing beams;
performing second LBT based on the second sensing beam; and
based on success of the second LBT, performing the UL transmission through a transmission beam covered by the second sensing beam, through the at least one transceiver,
wherein maximum counter values related to the plurality of sensing beams are separately related to the plurality of sensing beams, respectively.

8. The UE of claim 7, wherein the first sensing beam is related to a specific synchronization signal block (SSB) index.

9. The UE of claim 8, wherein, based on the failure of the first LBT, the number of LBT failure indications related to the third sensing beam related to the specific SSB index is also counted.

10. The UE of claim 7, wherein the first sensing beam covers a transmission beam known by spatial relation information or a unified transmission configuration indicator (TCI) framework.

11. The UE of claim 10, wherein, based on the failure of the first LBT, both a first LBT failure counter value related to the transmission beam and the second LBT failure counter value related to the first sensing beam are counted.

12. The UE of claim 11, wherein the second sensing beam is selected based on at least one of the first LBT failure counter value reaching a first maximum value and the second LBT failure counter value reaching a second maximum value.

13. (canceled)

14. A method for performing uplink (UL) reception by a base station (BS) in a wireless communication system, the method comprising:
transmitting information related to a transmission beam for the UL reception; and
performing the UL reception based on the information related to the transmission beam,
wherein the UL reception is performed based on success of a first LBT based on a first sensing beam covering the transmission beam,
the first sensing beam is reselected from among a plurality of sensing beams based on that a number of consistent failures of a second LBT based on a sensing beam different from the first sensing beam reaches a maximum counter value related to the second sensing beam, and
maximum counter values related to the plurality of sensing beams are separately related to the plurality of sensing beams, respectively.

15-16. (canceled)
